(19) United States
(12) Patent Application Publication
(10) Pub. No.: US 2002/0153389 A1
(43) Pub. Date: Oct. 24, 2002

(54) Squeeze operated foam dispenser

(76) Inventors: David Michael Ross Creaghan, Hamilton (CA); Dean Philip Limbert, Oakwood (GB); Stewart Banks, Algarve (PT)

Correspondence Address: DOWELL & DOWELL PC, SUITE 309, 1215 JEFFERSON DAVIS HIGHWAY, ARLINGTON, VA, 22202

(21) Appl. No.: 10/142,942

(22) Filed: May 13, 2002

Related U.S. Application Data
(63) Continuation-in-part of application No. 09/566,633, filed on May 8, 2000, now abandoned.
(63) Continuation-in-part of application No. 09/649,049, filed on Aug. 29, 2000, now Pat. No. 6,394,315.

(51) Int. Cl. B67D 5/58

(52) U.S. Cl. 222/190

(57) ABSTRACT

A foam dispenser includes a resiliently deformable bottle which has an interior, a neck at one end thereof and an opposed end. The bottle has an at rest position and an under pressure position. A mixing chamber is proximate to the neck and has a soap inlet and an air inlet both upstream of an outlet. The outlet has a porous material thereover. The interior of the bottle is in flow communication with the mixing chamber through the soap inlet. An air tube extends from the mixing chamber into the interior of the bottle and has a distal end proximate to the opposed end of the bottle whereby the mixing chamber is also in flow communication with the interior of the bottle through the air tube. A self sealing pressure actuated valve is for selectively opening and closing the outlet and is responsive to pressure applied to the bottle.

### RELATED APPLICATIONS

This application is a continuation-in-part application of U.S. patent application Ser. No. 09/566,633 filed May 8, 2000 and of U.S. patent application Ser. No. 09/649,049 filed Aug. 29, 2000.

### FIELD OF THE INVENTION

This invention relates to foam dispensers and in particular squeeze operated foam dispensers.

### BACKGROUND OF THE INVENTION

Liquid dispensers for dispensing soap and the like are well known. There are a wide variety of liquid dispensers for use in association with liquid soap. Some of these dispense the soap or other liquid in the form of a foam.

A common dispenser for liquid soap includes a cap with a nozzle portion that pivots from an in use position to a stowed position. In the in use position the nozzle is in flow communication with the interior of the dispenser. In the stowed position the distal end of the nozzle is inside the cap and thus liquid cannot escape. The advantage of this common dispenser cap is that it uses relatively few parts and is easy to use. The disadvantage is that when the dispenser is in the nozzle down position and the nozzle is in the in use position liquid will likely seep out continuously. A further disadvantage is that this can only be used in association with regular soap and it cannot be used to produce a foam.

Another dispenser for liquid soap is shown in U.S. Pat. No. 4,324,349 issued to Kaufman on Apr. 13, 1982. This dispenser includes a squeeze bottle and an air pocket structure disposed at the lower end of the bottle. The air pocket structure is in flow communication with the inside of the bottle and has an outlet so that liquid can flow from the bottle into the air pocket and out the outlet. The disadvantage of this squeeze bottle is that it can only be used in association with regular soap. It will not produce a foam.

Alternatively foam dispensers are used to dispense soap in the form of foam. The advantage of these dispensers is there tends to be much less waste due to splashing or run-off since the foam has a much higher surface tension than the corresponding liquid. In addition, foam tends to be much easier to spread than the corresponding liquid. Foam dispensers typically fall into two general types. One type produces foam by injecting a jet of air. The second type uses a porous material or mesh to aid in the production of foam. A combination of liquid and air is mixed together and then forced through the mesh to form a foam.

One example of a foam dispenser is shown in U.S. Pat. No. 5,984,146 issued Nov. 16, 1999 to Kaufman. This foam dispenser includes a reservoir for containing a pool of liquid up to a predetermined level. The foam dispenser includes a discharge chamber which contains air above the level of the liquid and a discharge device which extends upwardly from the reservoir at least partly through the discharge chamber. The discharge device has an external outlet. The discharge device includes a foam chamber and pressure means, whereby pressure applied to the liquid in the reservoir drives liquid into the discharge device. This foam dispenser has a number of disadvantages. Specifically this foam dispenser includes a separate discharge or air chamber, which causes the device to be quite bulky. This foam dispenser has a number of components which make it more costly to manufacture than a device with fewer components. Further, the foam chamber of this foam dispenser has a plurality of very small pinprick sized holes in a tubular portion which would be difficult and expensive to produce. In addition, to modify this foam dispenser to produce different foam characteristics or to use a different consistency of foaming soap would require modifying the foam chamber and would be difficult and expensive to do.

Accordingly it would be advantageous to provide a foam dispenser that uses relatively few components, that is easy to produce and that is easy to use. Further it would be advantageous to provide a foam dispenser that is relatively compact.

### SUMMARY OF THE INVENTION

The present invention is directed to a foam dispenser which includes a resiliently deformable bottle which has an interior, a neck at one end thereof and an opposed end. The bottle has an at rest position and an under pressure position. A mixing chamber is proximate to the neck and has a soap inlet and an air inlet both upstream of an outlet. The outlet has a porous material thereover. The interior of the bottle is in flow communication with the mixing chamber through the soap inlet. An air tube extends from the mixing chamber into the interior of the bottle and has a distal end proximate to the opposed end of the bottle whereby the mixing chamber is also in flow communication with the interior of the bottle through the air tube. A self sealing pressure actuated valve is for selectively opening and closing the outlet and is responsive to pressure applied to the bottle.

Further features of the invention will be described or will become apparent in the course of the following detailed description.

### BRIEF DESCRIPTION OF THE DRAWINGS

The invention will now be described by way of example only, with reference to the accompanying drawings, in which:

FIG. 1 is a blown apart perspective view of the squeeze operated foam dispenser of the present invention showing a portion of the cap broken away;

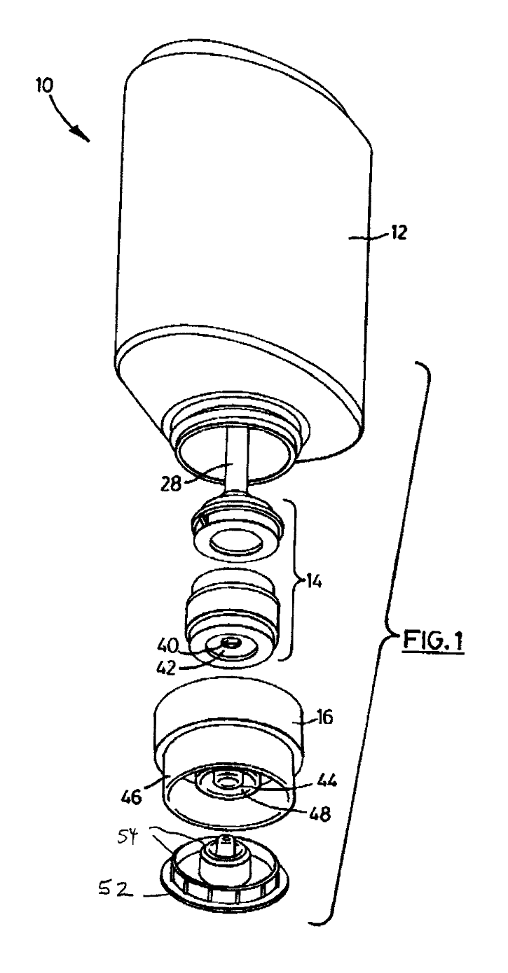

FIG. 2 is a cross sectional view of the foam dispenser shown in the at rest position;

FIG. 3 is a cross sectional view of the foam dispenser shown in an intermediate position between the at rest position and the open position;

FIG. 4 is a cross sectional view of the foam dispenser shown in the open or foam position;

FIG. 5 is a cross sectional view of a second embodiment of the foam dispenser of the present invention;

FIG. 6 is an enlarged cross sectional view of the nozzle portion of the embodiment of FIG. 5 shown in the open or foam position;

FIG. 7 is an enlarged cross sectional view similar to that shown in FIG. 6 but showing the nozzle portion after pressure has been released;

FIG. 8 is a cross sectional view of a third embodiment of the foam dispenser of the present invention;

FIG. 9 is an enlarged cross sectional view of the nozzle portion of the embodiment of FIG. 8 shown in the open or foam position;

FIG. 10 is an enlarged cross sectional view similar to that shown in FIG. 9 but showing the nozzle portion after pressure has been released;

FIG. 11 is an enlarged section view of the nozzle portion of a fourth embodiment of the foam dispenser of the present invention shown in the at rest position;

FIG. 12 is an enlarged section view of the foam dispenser shown in FIG. 11 but shown in the under pressure position;

FIG. 13 is a sectional view of a fifth embodiment of the foam dispenser of the present invention including an alternate mechanical pressure retaining valve shown in the at rest position; and

FIG. 14 is a sectional view of the foam dispenser shown in FIG. 13 but shown in the under pressure position.

### DETAILED DESCRIPTION OF THE INVENTION

Referring to the figures, the dispenser 10 includes a resiliently deformable bottle 12, a metering device 14 and a cap 16.

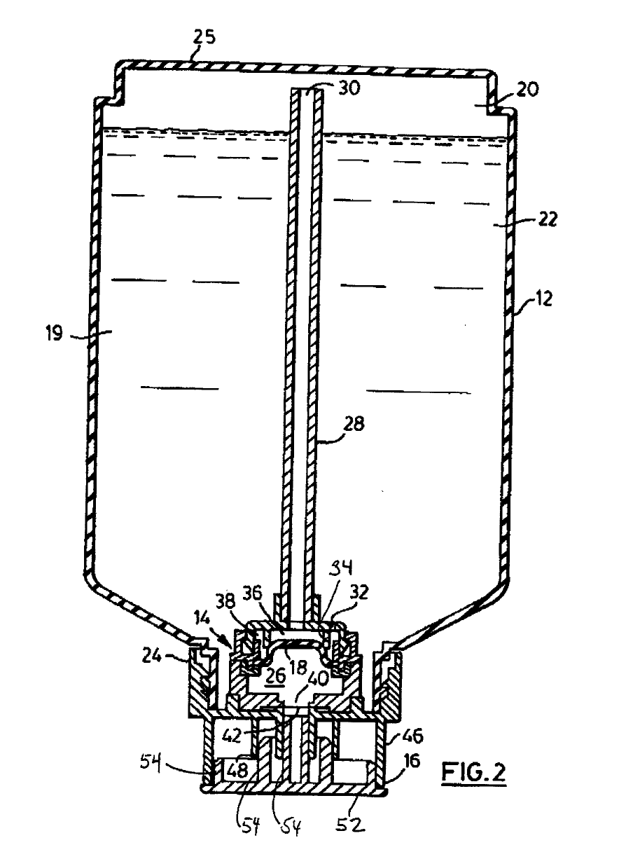

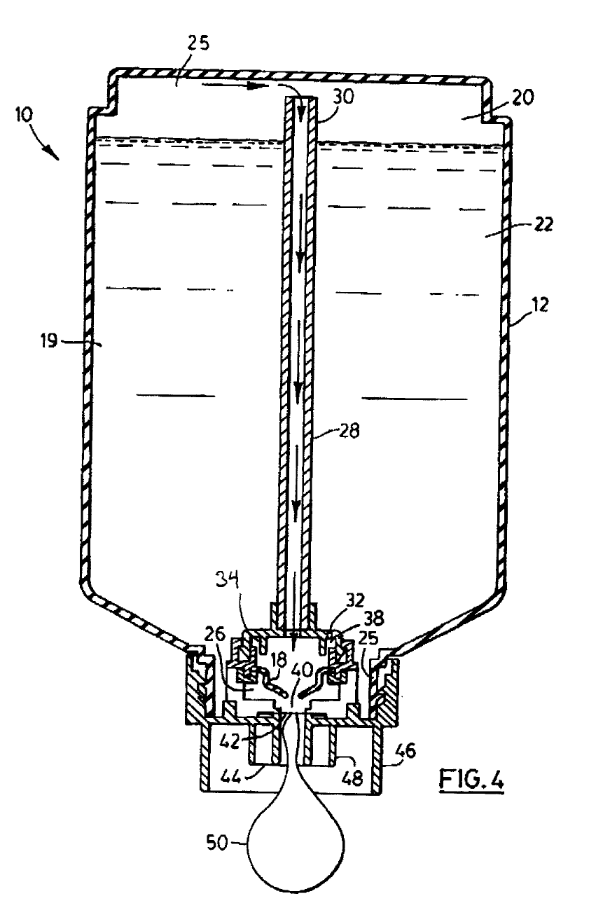

Resiliently deformable bottle 12 has an at rest position or an undeformed position (shown in FIG. 2) and is movable to a squeezed or under pressure position (shown in FIG. 4). It will be appreciated by those skilled in the art that the squeezed or under pressure position is not a single position per se but a range of positions wherein opening pressure of a sealing valve 18 (described in more detail below) in the metering device 14 is overcome. Bottle 12 will return to its undeformed or at rest position once the pressure is released. Pressure may be exerted on the bottle by squeezing it between the user's fingers and a thumb, by using a lever mechanism, by using an electric solenoid, by using a motor and the like. However, primarily bottle 12 is designed to be manually squeezed.

Bottle 12 has an interior volume 19 which serves as both an air chamber 20 and a soap chamber 22. In use foaming soap is poured into the bottle such that at least a portion is left for air. In the inverted position the air chamber 20 is at the top of the bottle 12. Bottle 12 narrows at one end thereof to form a neck 24 and has an opposed end 25. The metering device 14 is positioned in the neck and it is attached to the cap 16.

The metering device 14 includes a mixing chamber 26. The mixing chamber has an air tube 28 that extends into the interior 19 of the bottle 12. The distal end 30 of the air tube is proximate to the opposed end 25 of the bottle 12 whereby the mixing chamber 26 is in flow communication with the interior 19 of the bottle 12 through the air tube 28. When the bottle is in the inverted position as shown in FIGS. 2 to 4 the air tube 28 extends into the air chamber 20.

The mixing chamber 26 has a soap inlet 32 such that there is flow communication between the mixing chamber 26 and the interior 19 of the bottle through the soap inlet 32. An annular tube 34 extends downwardly from the air tube 28 into the mixing chamber 26. The annular tube 34 is positioned between the air tube 28 and the soap inlet 32 thereby defining an air portion 36 and a soap portion 38 which are isolated from each other when the valve 18 is in the closed position. The mixing chamber 26 has an outlet 40 over which a porous material or gauze material 42 extends. As shown in the drawings the mixing chamber may be constructed from a number of components that are attached together.

Self sealing pressure actuated valve 18 has an open position or under pressure (shown in FIG. 4) and a closed or at rest position (shown in FIG. 2). Valve 18 is for selectively opening and closing the air tube. Valve 18 is arranged such that when it is in the closed position the soap inlet 32 and the air tube 28 are closed. In the closed position valve 18 rests against annular tube 34 thereby closing soap inlet 32 and air tube 28. Valve 18 opens responsive to the bottle 12 being moved from the at rest position to the under pressure position.

Self sealing pressure actuated valve 18 is an elastomeric valve. Elastomeric valve is a pressure retaining valve that has an opening pressure that is high on the exhaust stroke but low on the intake stroke. An example of an elastomeric valve assembly that can be used in this application is a standard Zeller Plastik™ assembly part #4064.

Cap 16 is attached to the neck 24 of bottle 12. The cap 16 has a nozzle 44 in registration with the outlet 40 of the mixing chamber 26. Nozzle 44 extends outwardly from the bottle 12. A peripheral tube 46 extends outwardly from the edge of the cap 16. An intermediate tube 48 is spaced from the nozzle 44 and extends outwardly from the cap 16.

A transit cap 52 is attachable to cap 16. Transit cap 52 may have a plurality of annular tubes 54 which engage nozzle 44 and annular tubes 46, 48. The annular tubes 54 help to provide a seal during transit.

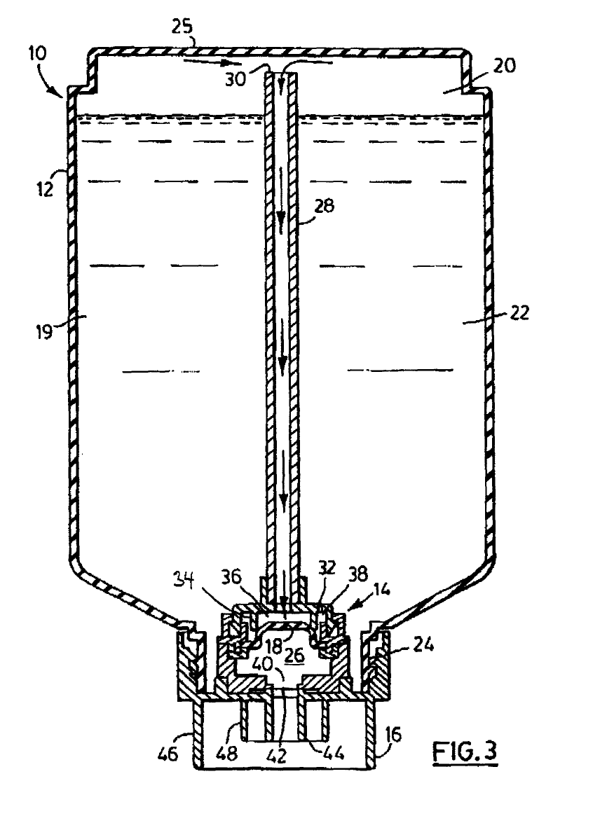

To dispense foam 50 a user would squeeze an at rest bottle 12 of dispenser 10 shown in FIG. 2. Firstly, a burst of air would be pushed down the air tube 28 into the air portion 36 of the mixing chamber 26 together with a burst of soap through soap inlet 32 thereby partially opening the valve 18 and unsealing the soap portion 38 of the mixing chamber 26 as shown in FIG. 3. As the pressure is increased valve 18 moves to the fully opened position shown in FIG. 4 and foam 50 is dispensed.

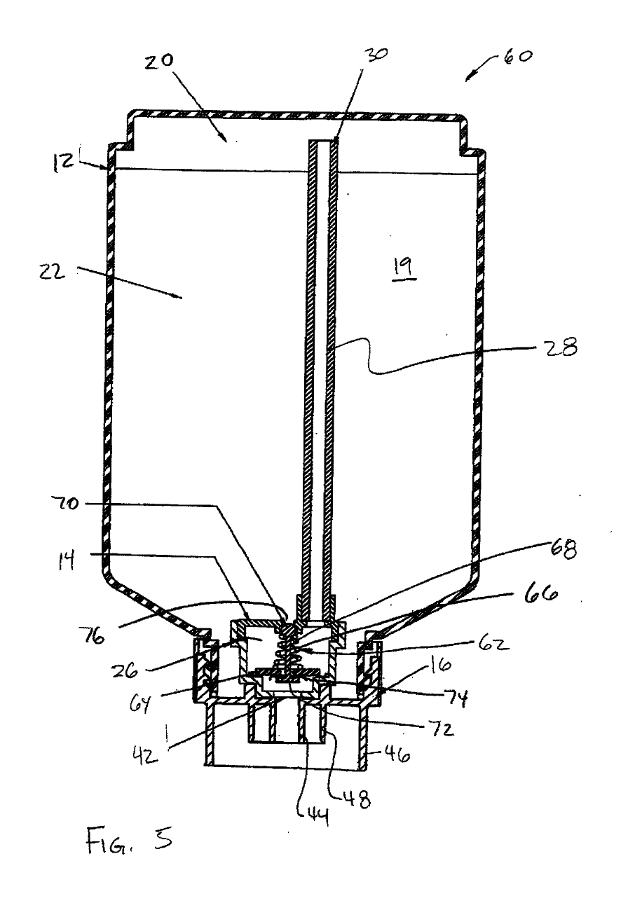

Referring to FIGS. 5 through 7, an alternate embodiment of the squeeze operated dispenser is shown generally at 60. Dispenser 60 is similar to dispenser 10 but it uses a mechanical shuttle valve 62 rather than the elastomeric valve 18. Shuttle valve 62 includes a valve disc 64, a central post 66 and a spring 68. Central post 66 has a ball 70 at one end thereof and a stopper 72 at the other end thereof. Valve disc 64 has a hole 74 in the middle thereof through which central post 66 extends. Ball 70 is positioned such that at rest it closes soap inlet 76, as shown in FIG. 5. At rest spring 68 pushes valve disc 64 into engagement with a stepped portion 78 of mixing chamber 26. A disc annular washer 80 extends outwardly from valve disc 64 to provide a better seal when it is in the at rest position. A stopper annular washer 82 extends outwardly from stopper 72 to provide a better seal when the shuttle valve 62 is in the at rest position. The remaining features, for example the bottle 12, air tube 28, air chamber 20 and cap 16 are as described above and accordingly will not be described again. Those features that are the same in dispenser 10 and dispenser 60 are given the same numeral in the figures.

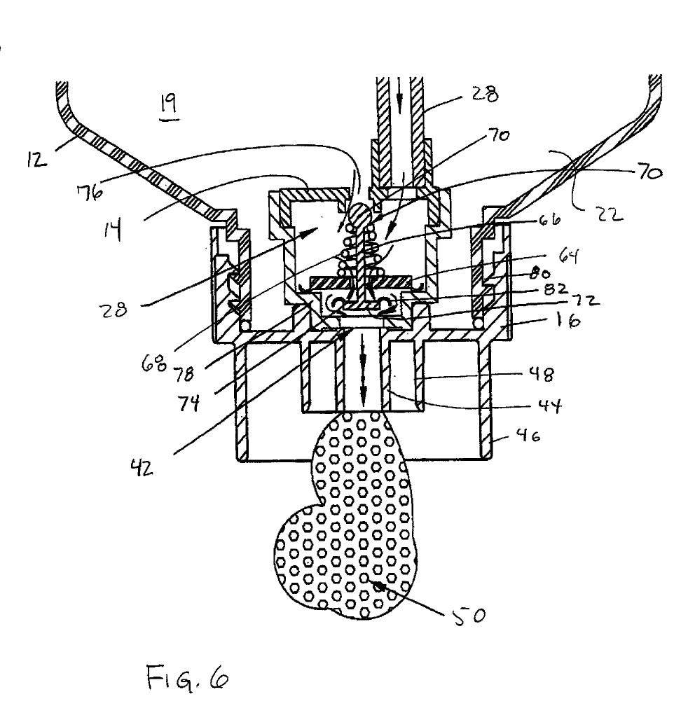

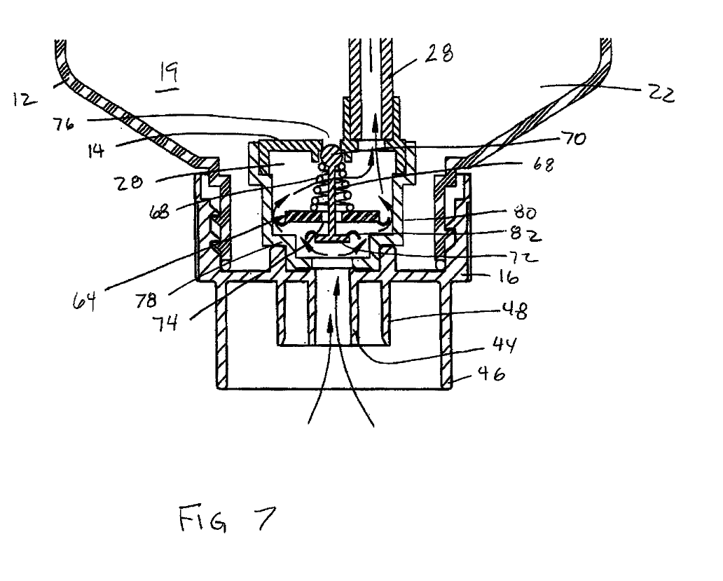

To dispense foam 50 a user would squeeze an at rest bottle 12 of dispenser 60 shown in FIG. 6. A burst of air would be pushed down the air tube 28 into the mixing chamber 26 and a burst of soap would be pushed through soap inlet 76 thereby opening the shuttle valve 62. Soap and air mix in mixing chamber 26 and exit through hole 74 then pass through gauze 42 to form foam 50. When pressure on bottle 12 is released a vacuum is formed within the bottle 12 and air is sucked back up nozzle 44 passed stopper 72, passed valve disc 64 and into air tube 28, as shown in FIG. 7. In addition ball 70 is moved into soap inlet 76 thereby sealing it.

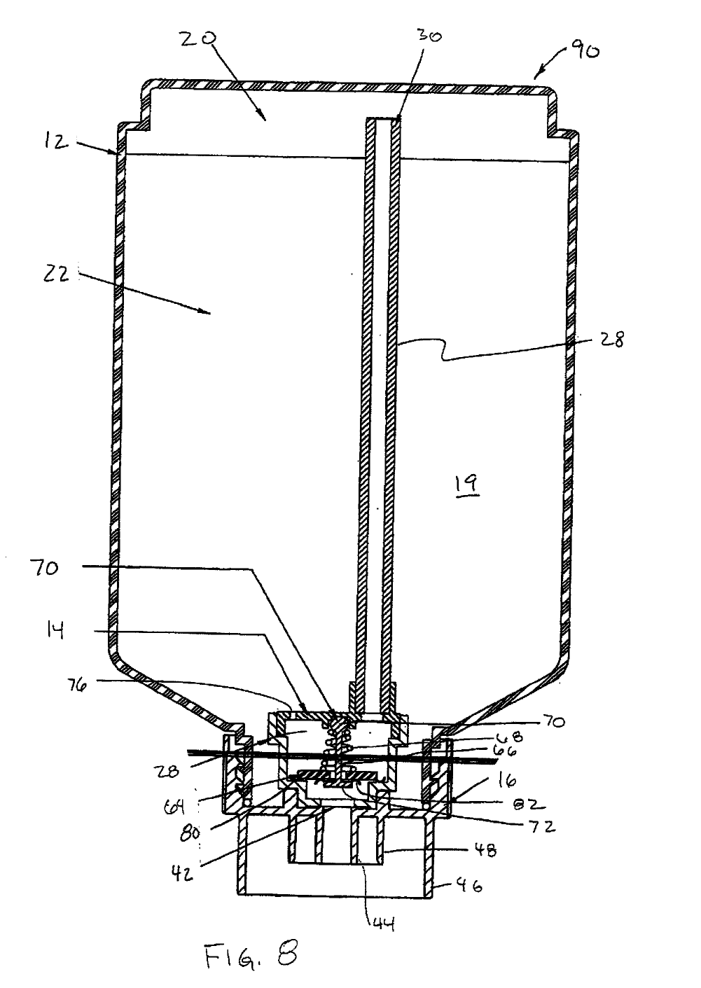

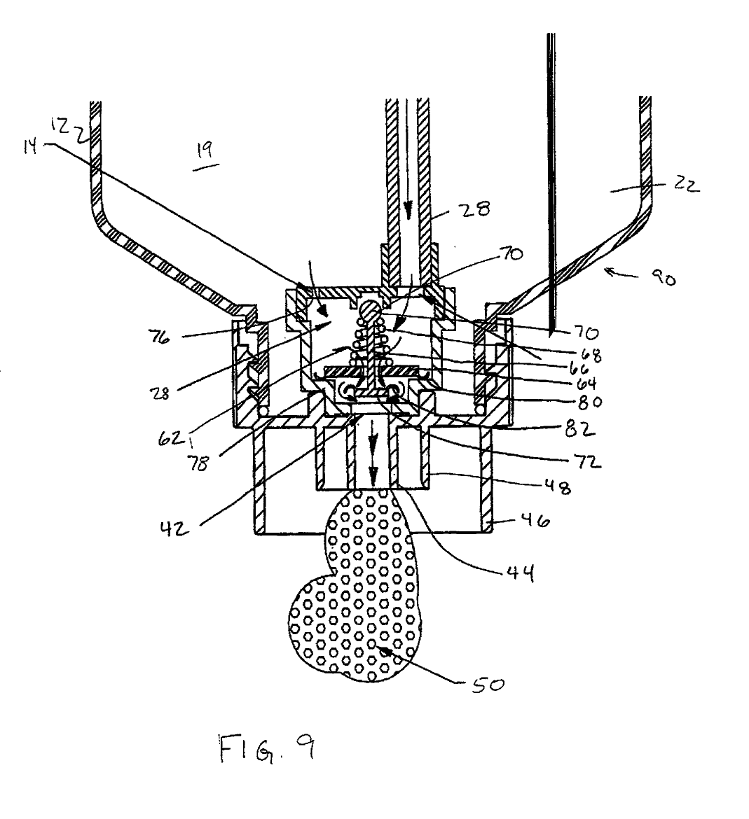

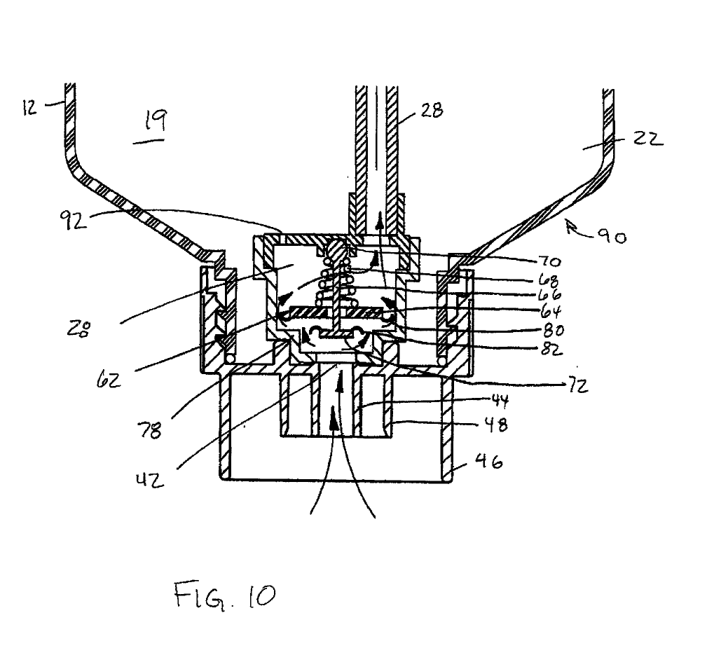

A second alternate embodiment is shown generally at 90 in FIGS. 8 through 10, this embodiment is similar to that shown in FIGS. 5 through 7 but the ball does not seal the soap inlet 76 when the shuttle valve 62 is in the at rest position. It should be noted that the positioning of shuttle valve 62 in dispenser 60 is the preferred orientation however the positioning in dispenser 90 also works. The disadvantage of the orientation in dispenser 90 is that the first shot of foam 50 is somewhat wetter than that of subsequent shots of foam 50. All features of dispenser 90 are the same as dispenser 60 with the exception of the position of the soap inlet 92 and the at rest position of the ball 70.

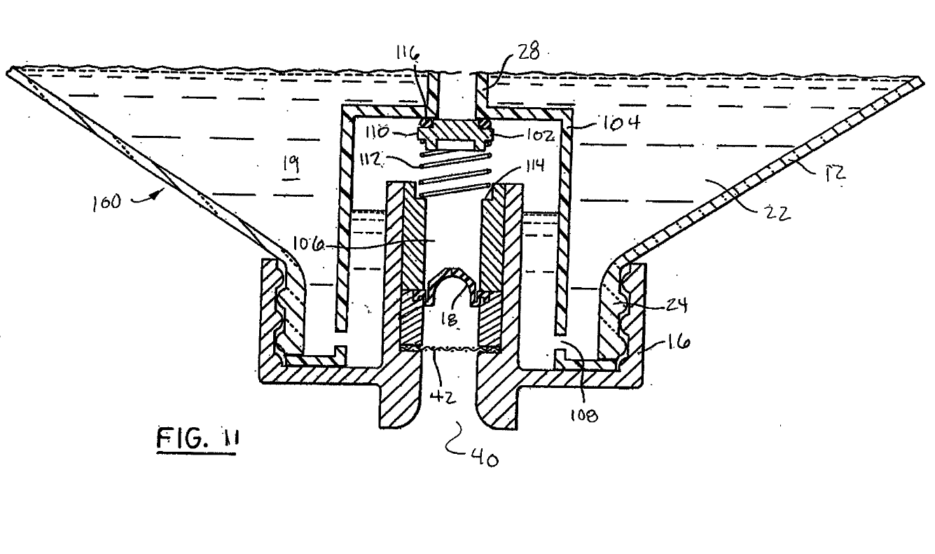

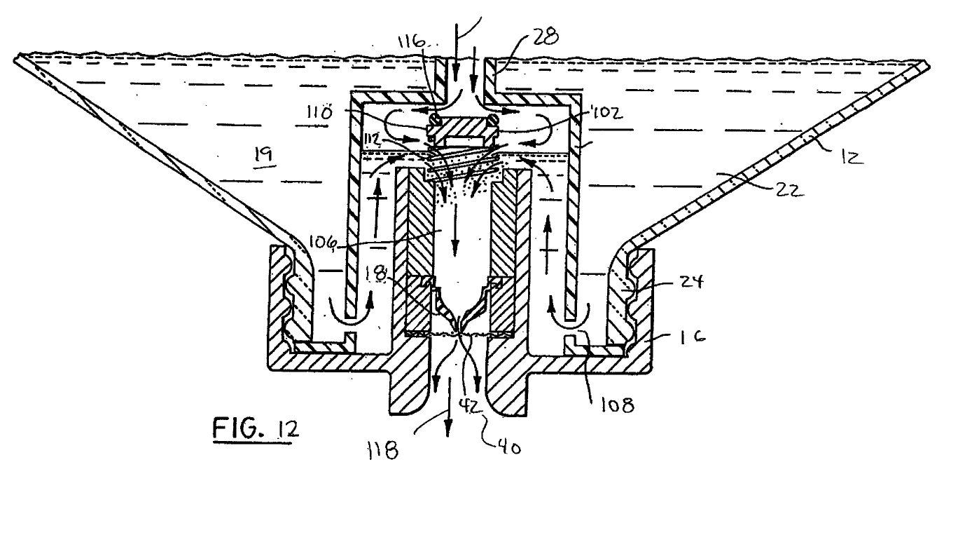

Referring to FIGS. 11 and 12 a soap dispenser 100 is similar to those shown previously but it includes a separate air inlet valve 102 for opening and closing the inlet to the air tube 28 in addition to the self sealing valve 18. The metering device 104 has similar characteristics to metering device 14 described above but it has a different configuration. Metering device 104 has a mixing chamber 106 with a pair of soap inlets 108. An air tube 28 extends from the mixing chamber 106. Air inlet valve 102 includes a stopper 110, a spring 112 and spring seat 114. Spring seat 114 is positioned in mixing chamber 106. Stopper 110 includes an O-ring 116. Spring 112 biases the stopper 110 into the closed or the at rest position wherein the O-ring 116 on stopper 110 rests against metering device 104 proximate to the air tube 28 thus effectively closing air tube 28 as shown in FIG. 11. Under pressure spring 112 is compressed and the stopper 110 moves away from the air tube 28 thus allowing air from the air tube 28 into mixing chamber 106 as shown by arrow 118 in FIG. 12. Self sealing valve 18 is positioned in mixing chamber 106 such that the soap inlets 108 and the air tube 28 is upstream thereof and the outlet 40 is downstream thereof. As described above the self sealing valve 18 may be an elastomeric valve which is a pressure retaining valve that has an opening pressure that is high on the exhaust stroke but low on the intake stroke.

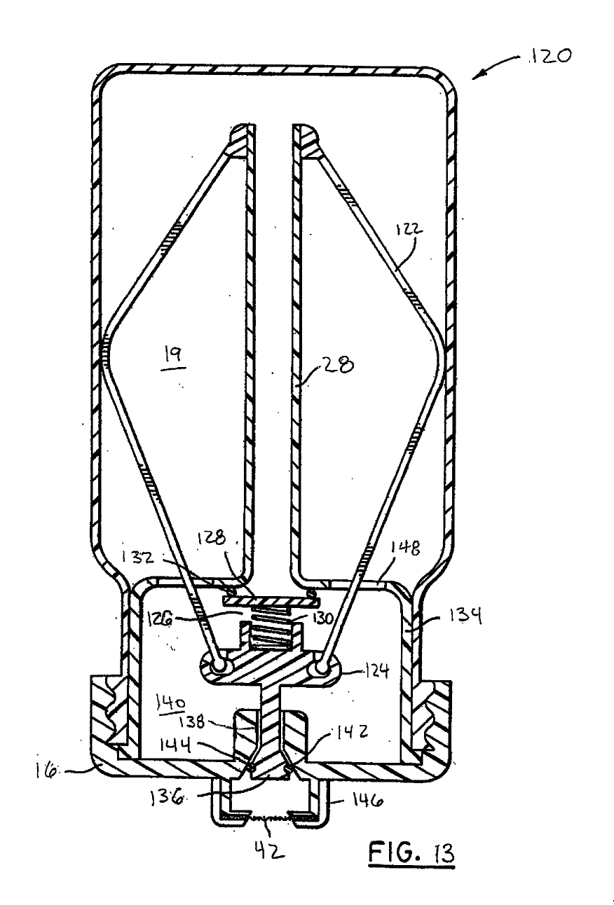

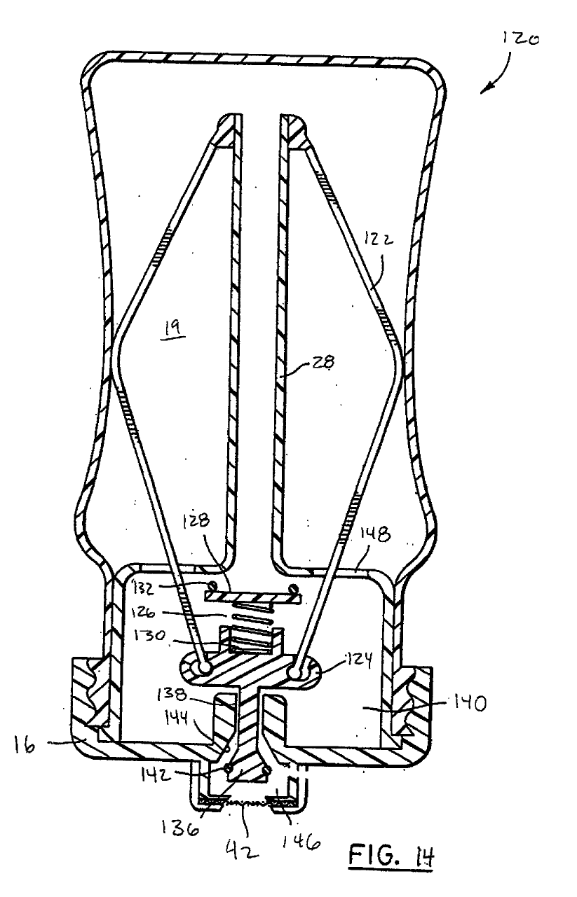

Referring to FIGS. 13 and 14 an alternate pressure retaining valve system is used with the squeeze operated foam dispenser 120. Dispenser 120 is similar to those described above but it includes an alternate pressure retaining valve. Following is a discussion of only those parts of dispenser 120 that are different from those described above. Dispenser 120 includes a leaf spring 122 which is preferably constructed from plastic. Leaf spring 122 is pivotally attached between air tube 28 and piston 124. A valve 126 somewhat similar to air inlet valve 102 is seated on piston 124 at one end thereof. Valve 126 includes a stopper 128, a spring 130 and an O-ring 132. Spring 130 biases the stopper 128 into the closed or the at rest position wherein the O-ring 132 on stopper 128 rests against the metering device 134 proximate to the air tube 28 thus closing air tube 28 as shown in FIG. 13.

Piston 124 includes a piston stopper portion 136 for sealing an outlet passage 138 in mixing chamber 140. O-ring 142 on piston stopper 136 seals against piston stopper seat 144 formed in mixing chamber 140. Gauze 42 is positioned at the mouth of nozzle 146. A pair of soap inlets 148 provide a fluid passageway between the interior 19 and the mixing chamber 140.

When dispenser 120 is squeezed, leaf springs 122 deform and piston stopper 136 moves out of the sealed position and there is a pressure build up such that spring 130 is compressed and the stopper 128 moves away from the air tube 28 thus allowing air from the air tube 28 into mixing chamber 140 as shown in FIG. 14. Mixing then occurs between the soap or other foaming liquid and the air in the mixing chamber 140 and nozzle 146.

Preferably bottle 12 will be attached to a wall such that the throat is always positioned downwardly. However it will be appreciated by those skilled in the art the foam dispenser described herein need not always be attached to the wall. In addition bottle 12 could be used in association with a lever mechanism, electric solenoid, motors and the like arranged to exert pressure on the bottle.

It will be appreciated that the above description was with regard to foaming liquids and in particular foaming soaps. However the liquid dispenser could also be used with other foaming detergents or other liquids wherein mixing with air is advantageous.

Accordingly it has been determined that a commercially acceptable dispenser is where a pressure actuated valve is positioned such that the air inlet and the soap inlet are on one side thereof and the gauze is on the other side thereof. However, it is preferable that in the at rest position the soap inlet is also closed by the valve.

It will be appreciated by those skilled in the art that when choosing the opening pressure for the self sealing pressure actuated valve 18, there are competing interests. For example the opening pressure responsive to squeezing the bottle should not be too high so that a user can easily obtain foam. On the other hand, if the opening pressure is too low it may be subject to leaking when the barometric pressure changes. However, once the valve has opened responsive to a shift in barometric pressure it will close once the internal and external pressures equalize.

As used herein, the terms “comprises” and “comprising” are to be construed as being inclusive and opened rather than exclusive. Specifically, when used in this specification including the claims, the terms “comprises” and “comprising” and variations thereof mean that the specified features, steps or components are included. The terms are not to be interpreted to exclude the presence of other features, steps or components.

It will be appreciated that the above description related to the invention by way of example only. Many variations on the invention will be obvious to those skilled in the art and such obvious variations are within the scope of the invention as described herein whether or not expressly described.

What is claimed as the invention is:

1. A foam dispenser for use in association with foaming liquids comprising:
a resiliently deformable bottle having an interior, a neck at one end thereof and an opposed end, the resiliently deformable bottle having an at rest position and an under pressure position;
a mixing chamber proximate to the bottle neck, having a soap inlet and an air inlet and an outlet downstream of the soap inlet and the air inlet whereby the interior of the bottle is in flow communication with the mixing chamber through the soap inlet;
an air tube extending from the air inlet in the mixing chamber into the interior of the bottle and having a distal end proximate to the opposed end of the bottle whereby the mixing chamber is in flow communication with the interior of the bottle through the air tube;
a porous material extending over the outlet of the mixing chamber; and
a self sealing pressure actuated valve positioned in the mixing chamber having the air inlet and the soap inlet on one side thereof and the outlet on the other side thereof, the valve having an open position and a closed position for selectively opening and closing the outlet whereby the valve is closed when the bottle is in the at rest position and opens responsive to the bottle being moved from the at rest position to the under pressure position.

2. A foam dispenser as claimed In claim 1 wherein the pressure actuated valve further selectively opens and closes one of the soap inlet and the air inlet.

3. A foam dispenser as claimed in claim 2 the pressure actuated valve has a higher opening pressure on the exhaust stroke than the closing pressure on the intake stroke.

4. A foam dispenser as claimed in claim 3 wherein an annular tube extends downwardly from the air tube into the mixing chamber between the air tube and the soap inlet thereby defining an air portion and a soap portion in the mixing chamber and the annular tube engages the self sealing pressure actuated valve when it is closed.

5. A foam dispenser as claimed in claim 4 wherein the pressure actuated valve selectively opens and closes the air inlet.

6. A foam dispenser as claimed in claim 5 wherein the self sealing pressure actuated valve is spaced from the porous material.

7. A foam dispenser as claimed in claim 6 further including a cap attached to the neck of the bottle, the cap having an opening in registration with the outlet of the mixing chamber.

8. A foam dispenser as claimed in claim 7 wherein the cap has a nozzle extending outwardly from the bottle around the opening in the cap.

9. A foam dispenser as claimed in claim 1 further including a cap attached to the neck of the bottle, the cap having an opening in registration with the outlet of the mixing chamber.

10. A foam dispenser as claimed in claim 9 wherein the cap has a nozzle extending outwardly from the bottle around the opening in the cap.

11. A foam dispenser as claimed in claim 1 wherein the self sealing pressure actuated valve is an elastomeric valve.

12. A foam dispenser as claimed in claim 2 wherein the self sealing pressure actuated valve is an elastomeric valve.

13. A foam dispenser as claimed in claim 3 wherein the self sealing pressure actuated valve is an elastomeric valve.

14. A foam dispenser as claimed in claim 4 wherein the self sealing pressure actuated valve is an elastomeric valve.

15. A foam dispenser as claimed in claim 11 wherein the elastomeric valve is a Zeller™ valve.

16. A foam dispenser as claimed in claim 12 wherein the elastomeric valve is a Zeller™ valve.

17. A foam dispenser as claimed in claim 1 wherein the self sealing pressure actuated valve is a shuttle valve.

18. A foam dispenser as claimed in claim 2 wherein the self sealing pressure actuated valve is a shuttle valve.

19. A foam dispenser as claimed in claim 3 wherein the self sealing pressure actuated valve is a shuttle valve.

20. A foam dispenser as claimed in claim 4 wherein the self sealing pressure actuated valve is a shuttle valve.

21. A foam dispenser as claimed in claim 1 further including a second self sealing pressure actuated valve for selectively opening and closing one of the soap inlet and the air inlet.

22. A foam dispenser as claimed in claim 21 wherein the second self sealing pressure actuated valve is an elastomeric valve.

23. A foam dispenser as claimed in claim 21 wherein the second self sealing pressure actuated valve includes a spring and a stopper.
